(19) United States
(12) Patent Application Publication
(10) Pub. No.: US 2024/0069895 A1
(43) Pub. Date: Feb. 29, 2024

(54) VEHICLE, VEHICLE CONTROL METHOD, COMMUNICATION SYSTEM, AND NON-TRANSITORY STORAGE MEDIUM

(71) Applicant: TOYOTA JIDOSHA KABUSHIKI KAISHA, Toyota-shi (JP)

(72) Inventor: Tomoyasu ISHIKAWA, Nagoya-shi (JP)

(73) Assignee: TOYOTA JIDOSHA KABUSHIKI KAISHA, Toyota-shi (JP)

(21) Appl. No.: 18/341,136

(22) Filed: Jun. 26, 2023

(30) Foreign Application Priority Data
Aug. 29, 2022 (JP) 2022-136066

(51) Int. Cl. G06F 8/65; B60K 35/00

(52) U.S. Cl. CPC G06F 8/65; B60K 35/00; B60K 2370/16

(57) ABSTRACT

A vehicle includes a communication device configured to execute communication between the vehicle and a communication instrument different from an instrument mounted on the vehicle, and a control device configured to control the vehicle. The control device is configured to acquire a plurality of types of progress in a process of updating software of the control device. The control device is configured to transmit information on first progress among the plurality of types of progress to the communication instrument by using the communication device. The control device is configured to transmit information on second progress different from the first progress among the plurality of types of progress to the communication instrument by using the communication device in response to a transmission request from the communication instrument.

### CROSS-REFERENCE TO RELATED APPLICATION

This application claims priority to Japanese Patent Application No. 2022-136066 filed on Aug. 29, 2022, incorporated herein by reference in its entirety.

### BACKGROUND

### 1. Technical Field

The present disclosure relates to a vehicle, a vehicle control method, a communication system, and a non-transitory storage medium.

### 2. Description of Related Art

Vehicles include a control device that controls operations of various on-board electric devices. When a control program of the control device is updated, a so-called over-the-air (OTA) technology may be used in addition to the use of update data transmitted by wire. In the OTA technology, the control program of the control device is updated by using update data received from an external server via wireless communication. When the control program is updated by using such an OTA technology, software is downloaded from the external server, for example, via an on-board communication instrument (for example, a data communication module (DCM)) or a terminal owned by a user (for example, a mobile phone such as a smartphone).

Japanese Unexamined Patent Application Publication No. 2017-149323 (JP 2017-149323 A) discloses, for example, a technology for requesting download of update software based on the location of an electronic key when a control device receives a notification about software update from a server via a mobile device.

### SUMMARY

When the update data is downloaded by using the on-board communication instrument or the terminal, the user is notified about a plurality of types of progress of an update process involving download, installation, and the like. Such notification is performed by using a display device mounted on the vehicle, a display device of the terminal owned by the user, or the like. When the notification is performed always for both the display device of the vehicle and the display device of the terminal, however, unnecessary communication may occur. Further, the power consumption of a notifying instrument of the vehicle or the like or a notified instrument of the terminal or the like may increase.

The present disclosure provides a vehicle, a vehicle control method, a communication system, and a non-transitory storage medium in which unnecessary communication and power consumption are reduced in a software update process.

A vehicle according to a first aspect of the present disclosure includes a communication device configured to execute communication between the vehicle and a communication instrument different from an instrument mounted on the vehicle, and a control device. The control device is configured to control the vehicle. The control device is configured to acquire a plurality of types of progress in a process of updating software of the control device. The control device is configured to transmit information on first progress among the plurality of types of progress to the communication instrument by using the communication device. The control device is configured to transmit information on second progress different from the first progress among the plurality of types of progress to the communication instrument by using the communication device in response to a transmission request from the communication instrument.

In the vehicle according to the first aspect of the present disclosure, the first progress may include at least one of progress of transmission of update information for the software to the vehicle and progress of an update process for the software in the vehicle.

In the vehicle according to the first aspect of the present disclosure, the control device may be configured to transmit the information on the second progress to the communication instrument when the transmission request is received from the communication instrument before an update process for the software is completed.

The vehicle according to the first aspect of the present disclosure may further include a notification device configured to notify an occupant of the vehicle about the plurality of types of progress.

A vehicle control method according to a second aspect of the present disclosure includes acquiring a plurality of types of progress in a process of updating software of a control device configured to control a vehicle, transmitting information on first progress among the plurality of types of progress to a communication instrument different from an instrument mounted on the vehicle, and transmitting information on second progress different from the first progress among the plurality of types of progress to the communication instrument in response to a transmission request from the communication instrument.

A communication system according to a third aspect of the present disclosure includes a vehicle including a control device configured to control the vehicle, a terminal configured to communicate with the vehicle, and a server. The server is configured to communicate with the vehicle. The server is configured to transmit update information to be used for updating software of the control device. The control device is configured to acquire a plurality of types of progress in a process of updating the software by using the received update information. The control device is configured to transmit information on first progress among the plurality of types of progress to at least one instrument out of the terminal and the server. The control device is configured to transmit information on second progress different from the first progress among the plurality of types of progress to the one instrument in response to a transmission request from the one instrument.

A non-transitory storage medium according to a fourth aspect of the present disclosure may store instructions that are executable by one or more processors and that cause the one or more processors to perform functions. The functions may include the vehicle control method according to the second aspect of the present disclosure.

With the present disclosure, it is possible to provide the vehicle, the vehicle control method, the communication system, and the non-transitory storage medium in which unnecessary communication and power consumption are reduced in the software update process.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates an example of the configuration of a communication system;

FIG. 2 is a flowchart showing an example of a process to be executed in a vehicle;

FIG. 3 shows an example of operations of a data center, a user terminal, and an electronic control unit (ECU) when updating a control program of the vehicle;

FIG. 4 shows another example of the operations of the data center, the user terminal, and the ECU when updating the control program of the vehicle; and

FIG. 5 shows an example of operations of the data center, the user terminal, and the ECU when updating the control program of the vehicle according to a modification.

### DETAILED DESCRIPTION OF EMBODIMENTS

Hereinafter, an embodiment of the present disclosure will be described in detail with reference to the drawings. The same or corresponding parts are denoted by the same signs throughout the drawings, and description thereof will not be repeated.

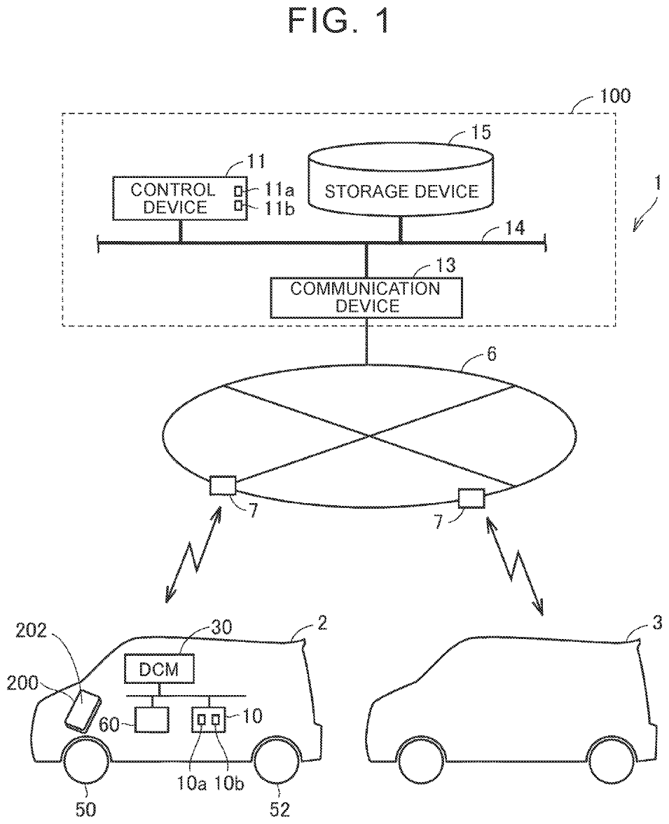

FIG. 1 illustrates an example of the configuration of a communication system 1. As shown in FIG. 1, in the present embodiment, the communication system 1 includes a plurality of vehicles 2, 3, a communication network 6, base stations 7, a data center 100, and a user terminal 200.

The vehicles 2, 3 may be, for example, vehicles using engines as their drive sources. Alternatively, the vehicles 2, 3 may be battery electric vehicles using electric motors as their drive sources. The vehicles 2, 3 may be hybrid electric vehicles each including an engine and an electric motor and using at least one of them as a drive source. For convenience of description, only two vehicles 2, 3 are shown in FIG. 1. The number of vehicles is not particularly limited to two, and may be three or more.

The communication system 1 acquires predetermined information from the vehicles 2, 3 configured to communicate with the data center 100, and is provided with predetermined information from the vehicles 2, 3. The communication system 1 manages acquired information and information to be provided.

The data center 100 includes a control device 11, a communication device 13, a storage device 15, and a communication bus 14. The control device 11, the communication device 13, and the storage device 15 are connected to each other via the communication bus 14 to communicate with each other. The data center 100 is an example of a “server” in the present embodiment.

The control device 11 includes a processor 11a such as a central processing unit (CPU) that executes programs, a memory 11b (such as a read-only memory (ROM) and a random access memory (RAM)), and an input and output port (not shown) for inputting and outputting various signals. Various types of control are performed by the control device 11 by software processing, that is, by the processor 11a reading a program stored in the memory 11b. The memory 11b may be a non-transitory storage medium. The various types of control that are performed by the control device 11 can also be implemented by a general-purpose computer (not shown) executing a program stored in a storage medium. The various types of control that are performed by the control device 11 need not be implemented by the software processing, and may be implemented by processing with dedicated hardware (electronic circuit).

The storage device 15 stores predetermined information on the vehicles 2, 3 configured to communicate with the data center 100. The predetermined information includes, for example, information on control programs for each vehicle 2 or 3 described later, and information for identifying each vehicle 2 or 3 (hereinafter referred to as “vehicle identification (ID)”). The vehicle ID is unique information set for each vehicle. The data center 100 can identify a transmitting vehicle or a receiving vehicle by the vehicle ID.

The communication device 13 implements bidirectional communication between the control device 11 and the communication network 6. The data center 100 can communicate with a plurality of vehicles including the vehicles 2, 3 via the base stations 7 on the communication network 6 by using the communication device 13. The data center 100 can communicate with a plurality of user terminals including the user terminal 200 via the base stations 7 on the communication network by using the communication device 13.

The user terminal 200 is, for example, a mobile terminal owned by a user of the vehicle 2, such as a smart phone, a tablet terminal, or a wearable device. The user terminal 200 is a computer (not shown) including a processor such as a CPU that executes programs, a memory, and an input and output interface. The user terminal 200 further includes a human-machine interface (HMI) device 202. The HMI device 202 includes a configuration, such as a touch panel display, in which an input device and a display device are combined. The input device receives various operations input by the user. The display device displays various types of information on a screen. The input device and the display device may be provided separately. The user terminal 200 is configured to communicate with the data center 100 via the base station 7. The data center 100 stores, for example, identification information of the user terminal 200 (for example, a telephone number or a manufacturing number) and the vehicle ID of the vehicle 2 in association with each other.

Next, specific configurations of the vehicles 2, 3 will be described. The vehicles 2, 3 basically have a common configuration. The configuration of the vehicle 2 will representatively be described below.

The vehicle 2 includes driving wheels 50 and driven wheels 52. When the driving wheels 50 are rotated by an operation of the drive source, a driving force acts on the vehicle 2 and the vehicle 2 travels accordingly.

The vehicle 2 further includes an electronic control unit (ECU) 10, the data communication module (DCM) 30, and an HMI device 60.

The ECU 10 is a computer including a processor 10a such as a CPU that executes programs, a memory 10b, and an input and output interface (not shown). The ECU 10 includes various control programs for controlling various actuators mounted on the vehicle 2. The various control programs include, for example, control programs for at least one of steering control, drive control, and braking control. The various control programs may include, for example, a program for implementing a driving assistance system having functions related to driving assistance for the vehicle 2. The driving assistance system includes, for example, an autonomous driving system (AD), an automated parking system, and an advanced driver assist system (ADAS).

The DCM 30 is a communication module configured to perform bidirectional communication with the data center 100 via the communication network 6 and the base station 7. For example, the DCM 30 can download update data for the control program from the data center 100 and can communication with the user terminal 200. In the present embodiment, description will be given of an example in which the DCM 30 can communicate with the user terminal 200. The vehicle 2 may further include, in addition to the DCM 30, a short-range communication device (not shown) configured to execute short-range communication with the user terminal 200. The short-range communication between the user terminal 200 and the short-range communication device includes, for example, wireless communication based on a predetermined standard (for example, Wi-Fi (registered trademark) communication or Bluetooth (registered trademark) communication).

The HMI device 60 includes a configuration, such as a touch panel display, in which an input device and a display device are combined. The input device receives input of various operations by the user. The display device displays various types of information on a screen. The input device and the display device may be provided separately.

In the vehicles 2, 3 configured as described above, an over-the-air (OTA) technology may be used for the ECU 10 to update, for example, any one of the various control programs stored in the memory. In the OTA technology, the control program is updated by using update information received from the data center 100 outside the vehicle 2 by wireless communication. With such an OTA technology, update programs can be provided even after the vehicle 2 has been put on the market to, for example, modify or add functions.

When the control program is updated by using such an OTA technology, for example, software update data for the ECU 10 is downloaded from the data center 100 that is a server outside the vehicle 2.

When the update data is downloaded and update is executed, the user is notified about the progress of a download process and an installation process. Examples of targets of such notification include the HMI device 60 mounted on the vehicle 2 and the HMI device 202 of the user terminal 200. When the notification is performed always for both the HMI device 60 of the vehicle 2 and the HMI device 202 of the user terminal 200, however, unnecessary communication may occur and the power consumption of the vehicle 2 or the user terminal 200 may increase.

For example, when the user tends to pay more attention to the HMI device 60 of the vehicle 2 than to the user terminal 200, the user will only pay attention to the HMI device 60 even if notification is given to both of them. Therefore, the communication for the notification on the user terminal 200 is unnecessary and the power consumption increases due to the unnecessary communication.

Therefore, in the present embodiment, the ECU 10 of the vehicle 2 transmits, to the user terminal 200 different from instruments mounted on the vehicle 2, information on first progress among a plurality of types of progress acquired in the process of updating the software of the ECU 10. In response to a transmission request from the user terminal 200, the ECU 10 of the vehicle 2 transmits information on second progress different from the first progress among the plurality of types of progress to the user terminal 200.

Therefore, the information on the second progress among the plurality of types of progress in the process of updating the software of the ECU 10 mounted on the vehicle 2 is not transmitted unless the request is given from the user terminal 200. Thus, unnecessary communication with the user terminal 200 and an increase in the power consumption due to the unnecessary communication are suppressed.

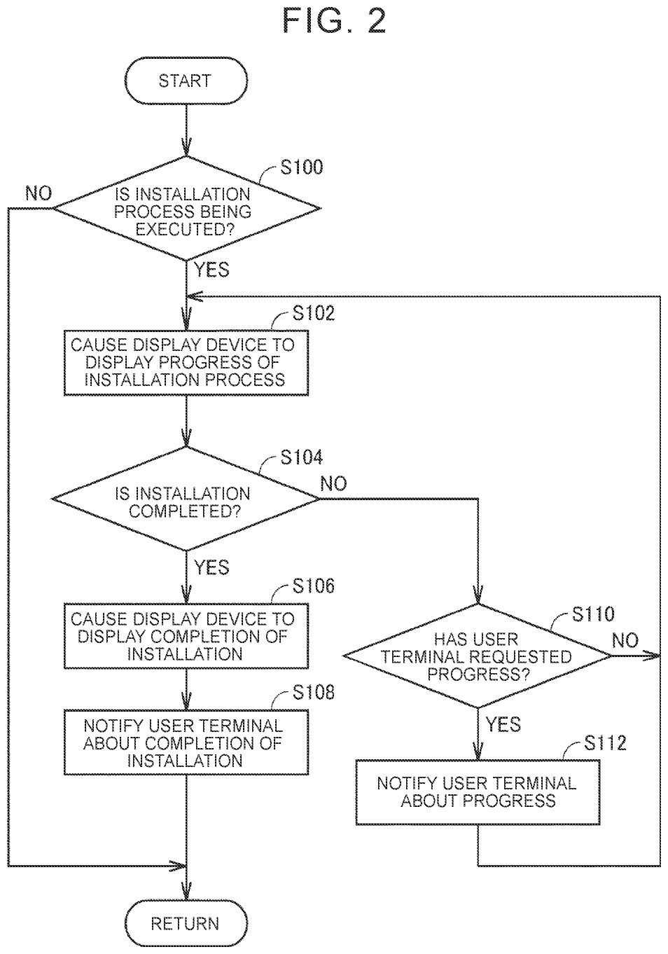

Hereinafter, an example of a process to be executed in the vehicle 2 (specifically, the ECU 10) will be described with reference to FIG. 2. FIG. 2 is a flowchart showing the example of the process to be executed in the vehicle 2. The process shown in this flowchart is repeatedly executed by the ECU 10 of the vehicle 2 at predetermined control cycles.

In Step S100, the ECU 10 determines whether the installation process is being executed. For example, the ECU 10 sets a flag to an ON state when the installation process is started after software update data for the ECU 10 has been received via the DCM 30. The ECU 10 sets the flag to an OFF state when the installation process is completed. The ECU 10 uses the state of the flag to determine whether the installation process is being executed. For example, the ECU 10 determines that the installation process is being executed when the flag is in the ON state. When determination is made that the installation process is being executed (YES in Step S100), the process proceeds to Step S102.

In Step S102, the ECU 10 causes the display device of the HMI device 60 to display the progress of the update data installation process. The ECU 10 calculates the progress during the execution of the installation process. The progress indicates, for example, the ratio of a period from the start of the installation process to the current time to a period from the start of the installation process to the completion of the installation process. The progress is represented, for example, by percentage. The period from the start of the installation process to the completion of the installation process is calculated by using, for example, the amount of the update data. For example, the ECU 10 activates a timer when the installation process is started, and measures an elapsed period from the start time. The ECU 10 calculates the period measured by the timer as the period from the start of the installation process to the current time. The ECU 10 causes the display device of the HMI device 60 to display the calculated progress. For example, the ECU 10 may cause the display device to display the progress as text information, or may cause the display to display an image of the progress in a graph such as a bar graph. Then, the process proceeds to Step S104.

In Step S104, the ECU 10 determines whether the update data installation process is completed. For example, the ECU 10 may determine that the update data installation process is completed when the value indicating the progress has reached a value indicating 100% or when the measured elapsed period has reached the period from the start of the installation process to the completion of the installation process. Alternatively, the ECU 10 may determine that the update data installation process is completed when the state of the flag changes from the ON state to the OFF state. When determination is made that the update data installation process is completed (YES in Step S104), the process proceeds to Step S106.

In Step S106, the ECU 10 causes the display device of the HMI device 60 to display information indicating the completion of the installation. The ECU 10 may cause the screen of the display device of the HMI device 60 to display, for example, text information indicating the completion of the installation. Then, the process proceeds to Step S108.

In Step S108, the ECU 10 notifies the user terminal 200 about the completion of the installation. For example, the ECU 10 transmits, to the user terminal 200 as a notification target, information indicating the completion of the process of installing the update data for the ECU 10. The user terminal 200 is associated with the vehicle ID of the vehicle 2 including the ECU 10. After then, the process is terminated. When determination is made that the update data installation process is not completed (NO in Step S104), the process proceeds to Step S110.

In Step S110, the ECU 10 determines whether the user terminal 200 has requested the progress. For example, the ECU 10 determines that the user terminal 200 has requested the progress when the ECU 10 receives, from the user terminal 200, information indicating a request for transmission of the progress. For example, the user terminal 200 requests the ECU 10 to transmit the progress in response to a user's operation. When determination is made that the user terminal 200 has requested the progress (YES in Step S110), the process proceeds to Step S112.

In Step S112, the ECU 10 notifies the user terminal 200 of the progress. The ECU 10 transmits information indicating the most recently calculated progress to the user terminal 200 that has requested the progress. After then, the process returns to Step S102. The process returns to Step S102 also when determination is made that the user terminal 200 has not requested the progress (NO in Step S110). When determination is made that the installation process is not being executed (NO in Step S100), the process is terminated.

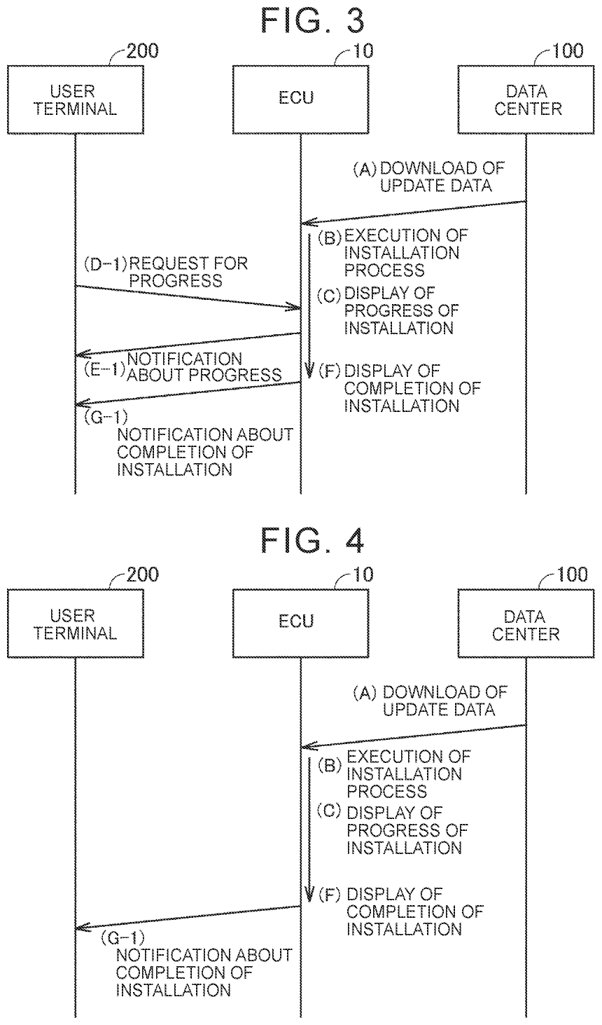

The operation of the vehicle 2 based on the structure and the flowchart described above will be described with reference to FIGS. 3 and 4. FIG. 3 shows an example of operations of the data center 100, the user terminal 200, and the ECU 10 when the control program of the vehicle 2 is updated. FIG. 4 shows another example of the operations of the data center 100, the user terminal 200, and the ECU 10 when the control program of the vehicle 2 is updated.

### Case Where User Terminal 200 Has Requested Progress

For example, it is assumed that the data center 100 is requested to transmit update data by an operation of an application in the user terminal 200 or an operation on the HMI device 60 of the vehicle 2 and the update data for the control program stored in the memory 10b of the ECU 10 has completed to be downloaded from the data center 100 as shown in (A) of FIG. 3.

When the download of the update data is completed, the ECU 10 executes the installation process by using the update data as shown in (B) of FIG. 3. The installation process includes, for example, a process of rewriting a part or the entirety of the target software.

When the installation process is being executed (YES in Step S100), the progress of the installation process is displayed on the display device of the HMI device 60 as shown in (C) of FIG. 3 (Step S102). When the user terminal 200 has requested the progress from the ECU 10 by a user's operation as shown in (D-1) of FIG. 3 (YES in Step S110) before the installation process is completed (NO in Step S104), the ECU 10 notifies the user terminal 200 of the current progress as shown in (E-1) of FIG. 3 (Step S112). That is, information indicating the most recently calculated progress is transmitted from the ECU 10 to the user terminal 200. The user terminal 200 causes the display device of the HMI device 202 to display the information received from the ECU 10 and indicating the progress. When the installation process is completed (YES in Step S104), a notification about the completion of the installation is given on the display device of the HMI device 60 as shown in (F) of FIG. 3 (Step S106). That is, information indicating the completion of the installation process is displayed on the display device of the HMI device 60. These pieces of information are displayed on the display device, for example, as text information or as image information including text information. As shown in (G-1) of FIG. 3, a notification about the completion of the installation is given on the display device of the HMI device 202 of the user terminal 200 (Step S108). That is, information indicating the completion of the installation process is transmitted from the ECU 10 to the user terminal 200. The user terminal 200 causes the display device of the HMI device 202 to display the information received from the ECU 10 and indicating the completion of the installation process.

### Case Where User Terminal 200 Has Not Requested Progress

For example, it is assumed that the data center 100 is requested to transmit update data by an operation of an application in the user terminal 200 or an operation on the HMI device 60 of the vehicle 2 and the update data for the control program stored in the memory 10b of the ECU 10 has completed to be downloaded from the data center 100 as shown in (A) of FIG. 4.

When the download of the update data is completed, the ECU 10 executes the installation process by using the update data as shown in (B) of FIG. 4.

When the installation process is being executed (YES in Step S100), the progress of the installation process is displayed on the display device of the HMI device 60 as shown in (C) of FIG. 4 (Step S102). When the installation process is completed (YES in Step S104), a notification about the completion of the installation is given on the display device of the HMI device 60 as shown in (F) of FIG. 4 (Step S106). As shown in (G-1) of FIG. 4, a notification about the completion of the installation is given on the display device of the HMI device 202 of the user terminal 200 (Step S108). That is, information indicating the completion of the installation process is transmitted from the ECU 10 to the user terminal 200. The user terminal 200 causes the display device of the HMI device 202 to display the information received from the ECU 10 and indicating the completion of the installation process.

Therefore, unnecessary notification to the user terminal 200 is suppressed until the installation process is completed.

As described above, in the vehicle 2 according to the present embodiment, the completion of the installation process (first progress) among the plurality of types of progress in the process of updating the software of the ECU 10 mounted on the vehicle 2 is transmitted even if no request is given from the user terminal 200. The information on the progress of the installation process (second progress) is not transmitted unless the request is given from the user terminal 200. Thus, unnecessary communication with the user terminal 200 and an increase in the power consumption due to the unnecessary communication are suppressed. Thus, it is possible to provide the vehicle, the vehicle control method, the communication system, and the non-transitory storage medium in which unnecessary communication and power consumption are reduced in the software update process.

In the present embodiment, the first progress includes the completion of the software update process (installation process) in the vehicle 2. The second progress includes the progress of the software installation process. Therefore, the progress of the installation process is transmitted to the user terminal 200 in response to a request from the user terminal 200. Thus, unnecessary communication can be suppressed.

The ECU 10 transmits the information on the progress of the installation process (second progress) to the user terminal when the ECU 10 receives a transmission request from the user terminal 200 before the software update process is completed. Thus, unnecessary communication can be suppressed.

The vehicle 2 includes the HMI device 60 that is a notification device that notifies an occupant of the vehicle 2 about the plurality of types of progress. Thus, the occupant of the vehicle 2 can check, on the HMI device 60, the plurality of types of progress in the process of updating the software.

Modifications will be described below.

In the above embodiment, description has been given of the exemplary case where processes are executed by using one processor 10a and one memory 10b in the ECU 10 of the vehicle 2. The process in the flowchart shown in FIG. 2 may be executed by one or more processors reading and executing programs stored in one or more memories.

In the above embodiment, the update data for the control program of the ECU 10 has been described as the example of the target of the download process and the installation process. The target may be update data for map information and a control program of a navigation system, and is not particularly limited.

In the above embodiment, description has been given of the exemplary case where the user terminal 200 including a communication instrument capable of communicating with the vehicle 2 requests the progress of the installation process and is notified about the progress of the installation process. The data center 100 including the communication device 13 may be a communication instrument that gives a request and receives a notification (a communication instrument different from the instrument mounted on the vehicle 2). In this case, the process to be executed by the ECU 10 of the vehicle 2 is the same as the process described with reference to the flowchart of FIG. 2 except that the communication target is the data center 100 instead of the user terminal 200. Therefore, detailed description thereof will not be repeated.

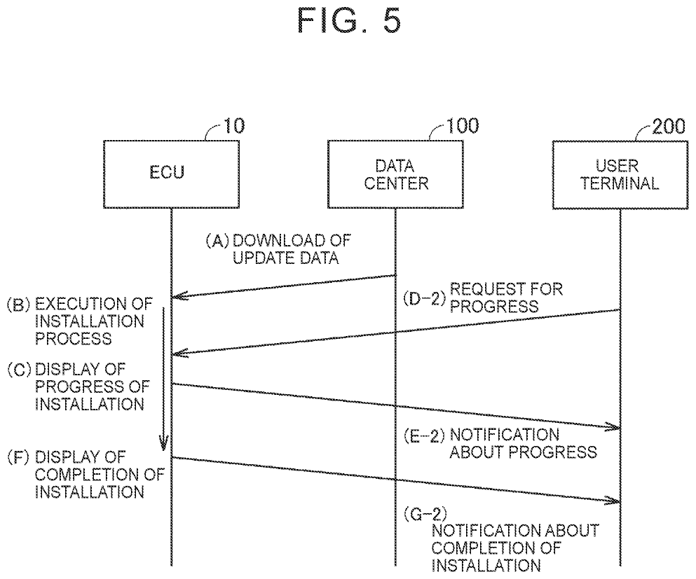

An example of operations of the data center 100, the user terminal 200, and the ECU 10 according to a modification will be described below with reference to FIG. 5. FIG. 5 shows the example of the operations of the data center 100, the user terminal 200, and the ECU 10 when the control program of the vehicle 2 is updated according to the modification.

For example, it is assumed that the data center 100 is requested to transmit update data by an operation of an application in the user terminal 200 or an operation on the HMI device 60 of the vehicle 2 and the update data for the control program stored in the memory 10b of the ECU 10 has completed to be downloaded from the data center 100 as shown in (A) of FIG. 5.

When the download of the update data is completed, the ECU 10 executes the installation process by using the update data as shown in (B) of FIG. 5.

When the installation process is being executed (YES in Step S100), the progress of the installation process is displayed on the display device of the HMI device 60 as shown in (C) of FIG. 5 (Step S102). When the user terminal 200 has requested the progress from the data center 100 by a user's operation as shown in (D-2) of FIG. 5 before the installation process is completed (NO in Step S104), the data center 100 requests the progress from the ECU 10 (YES in Step S110). As shown in (E-2) of FIG. 5, the ECU 10 notifies the data center 100 of the current progress (Step S112). The data center 100 notifies the user terminal 200 of the progress. When the installation process is completed (YES in Step S104), a notification about the completion of the installation is given on the display device of the HMI device 60 as shown in (F) of FIG. 5 (Step S106). As shown in (G-2) of FIG. 5, the data center 100 is notified of the completion of the installation. After then, information indicating the completion of the installation process is transmitted from the data center 100 to the user terminal 200. The user terminal 200 causes the display device of the HMI device 202 to display the information received from the ECU 10 and indicating the completion of the installation process.

Thus, unnecessary communication between the user terminal 200 and the data center 100 and between the data center 100 and the ECU 10 is suppressed when an operation for requesting the progress is not performed on the user terminal 200. By suppressing unnecessary communication, an increase in the power consumption in the user terminal 200 and the data center 100 can be suppressed.

In the above embodiment, description has been given under the assumption that the notification about the completion of the installation process is given even if no request is given from the user terminal 200 and the notification about the progress of the installation process is given when the request is given from the user terminal. For example, the notification about the progress of the installation process may be given even if no request is given from the user terminal, and the notification about the completion of the installation process may be given when the request is given from the user terminal.

In the above embodiment, description has been given of the example in which the first progress to be given as a notification to the user terminal and the second progress different from the first progress are the completion of the installation process and the progress of the installation process, respectively. The first progress and the second progress may be any of the plurality of types of progress in the process of updating the software of the ECU 10. For example, the plurality of types of progress includes at least one of progress of the update data download process, completion of the download process, progress of the installation process, and completion of the installation process. In this case, the first progress may include at least one of the progress of the update data download process, the completion of the download process, the progress of the installation process, and the completion of the installation process. The second progress may include at least progress different from the first progress among the progress of the update data download process, the completion of the download process, the progress of the installation process, and the completion of the installation process.

In the above embodiment, description has been given under the assumption that various notifications are given by displaying text information and images on the display device. For example, a device that generates sound or the like may be used to give various notifications.

A part or all of the above modifications may be combined as appropriate. The embodiment disclosed herein should be construed as illustrative in all respects and not restrictive. The scope of the present disclosure is shown by the claims rather than by the above description and is intended to include all modifications within the meaning and scope equivalent to the claims.

What is claimed is:

1. A vehicle comprising:
a communication device configured to execute communication between the vehicle and a communication instrument different from an instrument mounted on the vehicle; and
a control device configured to:
control the vehicle;
acquire a plurality of types of progress in a process of updating software of the control device;
transmit information on first progress among the plurality of types of progress to the communication instrument by using the communication device; and
transmit information on second progress different from the first progress among the plurality of types of progress to the communication instrument by using the communication device in response to a transmission request from the communication instrument.

2. The vehicle according to claim 1, wherein the first progress includes at least one of progress of transmission of update information for the software to the vehicle and progress of an update process for the software in the vehicle.

3. The vehicle according to claim 1, wherein the control device is configured to transmit the information on the second progress to the communication instrument when the transmission request is received from the communication instrument before an update process for the software is completed.

4. The vehicle according to claim 1, further comprising a notification device configured to notify an occupant of the vehicle about the plurality of types of progress.

5. A vehicle control method comprising:
acquiring a plurality of types of progress in a process of updating software of a control device configured to control a vehicle;
transmitting information on first progress among the plurality of types of progress to a communication instrument different from an instrument mounted on the vehicle; and
transmitting information on second progress different from the first progress among the plurality of types of progress to the communication instrument in response to a transmission request from the communication instrument.

6. A communication system comprising:
a vehicle including a control device configured to control the vehicle;
a terminal configured to communicate with the vehicle; and
a server configured to
communicate with the vehicle, and
transmit update information to be used for updating software of the control device, wherein the control device is configured to:
acquire a plurality of types of progress in a process of updating the software by using the update information received;
transmit information on first progress among the plurality of types of progress to at least one instrument out of the terminal and the server; and
transmit information on second progress different from the first progress among the plurality of types of progress to the one instrument in response to a transmission request from the one instrument.

7. A non-transitory storage medium storing instructions that are executable by one or more processors and that cause the one or more processors to perform functions comprising the vehicle control method according to claim 5.
